(19) United States
(12) Patent Application Publication
(10) Pub. No.: US 2015/0156529 A1
(43) Pub. Date: Jun. 4, 2015

(54) SYSTEMS AND METHODS FOR SELECTIVELY TRANSMITTING USER INTERACTION INFORMATION BASED ON BIOMETRIC INFORMATION

(71) Applicant: United Video Properties, Inc., Santa Clara, CA (US)

(72) Inventor: Brian Peterson, Barrington, IL (US)

(73) Assignee: UNITED VIDEO PROPERTIES, INC., Santa Clara, CA (US)

(21) Appl. No.: 14/097,161

(22) Filed: Dec. 4, 2013

(51) Int. Cl. H04N 21/2668; H04N 21/4415; H04N 21/81; H04N 21/25; H04N 21/258; H04N 21/45; G06Q 30/02; H04N 21/422

(52) U.S. Cl. CPC H04N 21/2668; G06Q 30/0269; H04N 21/4415; H04N 21/42201; H04N 21/251; H04N 21/25891; H04N 21/4532; H04N 21/812

(57) ABSTRACT

Systems and methods for selectively transmitting user interaction information based on biometric information are discussed herein. In one embodiment, a first biometric state of a user may be associated with information on interactions the user performed while experiencing the first biometric state, and a second biometric state of the user may be associated with information on interactions the user performed while experiencing the second biometric state. A request for user interaction information associated with a particular biometric characteristic may be received from a server. A determination may then be made which of the first and the second biometric states corresponds to the particular characteristics, and, responsive to determining that the second biometric state corresponds to the particular biometric characteristic, information on the interactions the user performed while experiencing the second biometric state may be transmitted to the server.

### BACKGROUND

Advertisers and media content providers may monitor user interactions with advertisements and media content, respectively. For example, Nielsen ratings attempt to measure the size of a television audience, and Internet advertisers attempt to measure the click-through rate of online advertisements. However, such information only indicate that a user interacted with an advertisement or media content, but does not capture how engaged the user was with the advertisement or media content, and does not include any information on a physiological and/or psychological state the user experienced while interacting with the advertisement or media content.

### SUMMARY

In view of the foregoing, systems and methods for selectively transmitting user interaction information based on biometric information are provided.

In one embodiment, a first biometric state of a user may be associated with information on interactions the user performed while experiencing the first biometric state, and a second biometric state of the user may be associated with information on interactions the user performed while experiencing the second biometric state. A request for user interaction information associated with a particular biometric characteristic may be received from a server. A determination may be made regarding which of the first and the second biometric states corresponds to the particular characteristics, and, responsive to determining that the second biometric state corresponds to the particular biometric characteristic, information on the interactions the user performed while experiencing the second biometric state may be transmitted to the server.

In one embodiment, biometric information may be received from a biometric measurement device at a number of different times, and associating the second biometric state of the user with information on interactions the user performed while the user experienced the second biometric state may involve determining whether the user is experiencing the first or the second biometric state using the most recently received biometric information.

In one embodiment, at least one user command corresponding to at least one of the interactions the user performed while experiencing the second biometric state may be received, and, responsive to this user command, biometric information may be received from a biometric measurement device. This biometric information may then be used to determine whether the user is experiencing the first or the second biometric state as part of associating the second biometric state with information on interactions the user performed while experiencing the second biometric state. This embodiment may further involve transmitting a request for the biometric information to the biometric measurement device responsive to receiving the at least one user command, and receiving the biometric information in response to the request.

In one embodiment, a third biometric state of another user may be associated with information on interactions the other user performed while experiencing the third biometric state. A determination may be made regarding which of the first, second, and third biometric states correspond to the particular biometric characteristics, and, responsive to determining that both the second and third biometric states correspond to the particular biometric characteristics, both the information on interactions the first user performed while experiencing the second biometric state and the information on interactions the other user performed while experiencing the third biometric state may be transmitted to the server.

In one embodiment, the particular biometric characteristic may be one or more of a particular mood, a particular emotional state, or a range of at least one of heart rates, blood pressures, temperatures, and breathing rates. The particular biometric characteristic may also indicate a value of a biometric measurement relative to a value of this biometric measurement indicated by a stored historic biometric state.

In one embodiment, the particular biometric characteristic may be associated with a heightened level of user attention, and the information on interactions the user performed while experiencing the second biometric state may include a user score for a media asset. The server may receive user interaction information from a number of user equipment devices, with the received user interaction information including information on interactions users of these user equipment devices performed while experiencing a biometric state that corresponds to this particular biometric characteristic. The server may then use the received user interaction information to generate a reliable score for the media asset.

In one embodiment, the particular biometric characteristic may be associated with laughter, and the information on interactions the user performed while experiencing the second biometric state may include information identifying media assets. The server may receive user interaction information from a number of user equipment devices, with the received user interaction information including information on interactions users of these user equipment devices performed while experiencing a biometric state that corresponds to this particular biometric characteristic. The server may then use the received user interaction information to identify comedic media assets.

In one embodiment, the particular biometric characteristic may be associated with fear, and the information on interactions the user performed while experiencing the second biometric state may include information identifying media assets. The server may receive user interaction information from a number of user equipment devices, with the received user interaction information including information on interactions users of these user equipment devices performed while experiencing a biometric state that corresponds to this particular biometric characteristic. The server may then use the received user interaction information to identify horror media assets.

It should be noted that the systems and/or methods described above may be applied to, or used in combination with, other systems and/or methods as described below.

### BRIEF DESCRIPTION OF THE DRAWINGS

The above and other features of the present application, its nature and various advantages will become more apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments;

FIG. 3 shows an illustrative user equipment device in accordance with some embodiments;

FIG. 4 is a diagram of an illustrative cross-platform interactive media system in accordance with some embodiments;

FIG. 5 shows an illustrative display screen that includes media identifiers for comedic media assets that were identified based on biometric states experienced by users who interacted with these media assets in accordance with some embodiments;

FIG. 6 shows an illustrative display screen that includes scores for media assets that are deemed reliable based on biometric states of users who submitted scores for these media assets in accordance with some embodiments;

FIG. 7 shows an illustrative display screen that includes an advertisement targeted to a user based on a current biometric state of the user in accordance with some embodiments;

FIG. 8 shows an illustrative display screen that includes media identifiers for media assets that are recommended to a user based on a current biometric state of the user in accordance with some embodiments;

FIG. 9 is a flow chart of a process for associating a biometric state with information on interactions a user performed while experiencing the biometric state in accordance with some embodiments;

FIG. 10 is a flow chart of a process for transmitting user interaction information that is associated with a particular biometric characteristic to a server in accordance with some embodiments; and

FIG. 11 is a flow chart of a process for selectively collecting user interaction information associated with a particular biometric characteristic from a user equipment device in accordance with some embodiments.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media identifiers, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

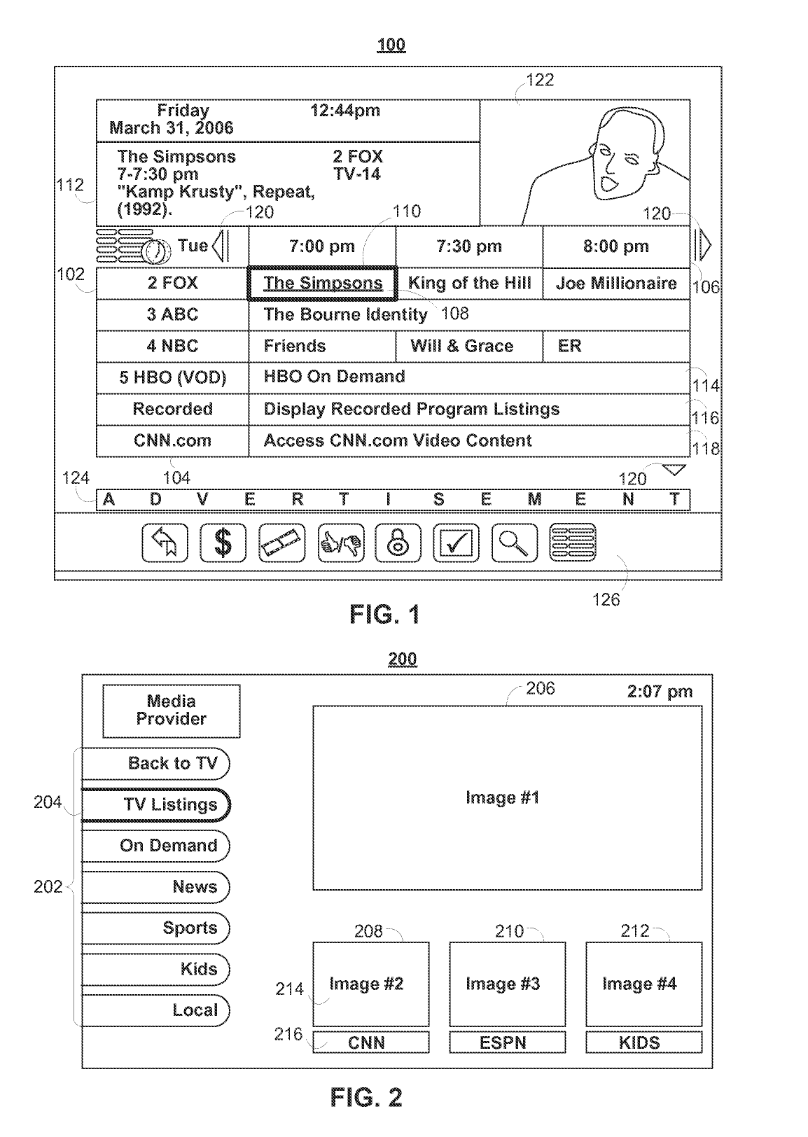

FIGS. 1-2 and 5-8 show illustrative display screens that may be used to provide media guidance data. The display screens shown in FIGS. 1-2 and 5-8 may be implemented on any suitable user equipment device or platform. While the displays of FIGS. 1-2 and 5-8 are illustrated as full screen displays, they may also be fully or partially overlaid over content being displayed. A user may indicate a desire to access content information by selecting a selectable option provided in a display screen (e.g., a menu option, a listings option, a media identifier, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings (also referred to as media identifiers), such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, a biometric state of the user, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, I I I et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity or a biometric state of the user to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user (such as a biometric measurement device), etc.), and/or obtain information about the user from other sources that the media guidance application may access.

The user profile information may also include information pertaining to one or more biometric states of the user. A biometric state can describe a user's physiological and/or psychological state. A biometric state may be associated with one or more biometric measurements, such as heart rate, breathing rate, temperature, blood pressure, blood sugar level, brain activity level, Serotonin level, or adrenaline level, and include values and/or ranges of values for any of these one or more biometric measurements. For example, heart rate may be a biometric measurement, while a current biometric state of a user may be the user's current heart rate. Information that indicates a biometric state for a user may be described as biometric information. Such information may be received from a biometric measurement device that measures one or more values of one or more biometric measurements and transmits the one or more values to the media guidance application. Alternatively or in combination, the media guidance application may also receive biometric information via a user input specifying a biometric state that the user is experiencing at that time or has previously experienced. The media guidance application may determine that a user is experiencing a particular biometric state (e.g., a happy mood) through either direct measurement (e.g., by measuring a user's Serotonin levels) or by an inference based on other biometric states (e.g., by determining that the user's heart rate is elevated, but that the user's blood pressure is normal). Accordingly, a particular biometric state (e.g., happy mood) may be described as a set of multiple other biometric states (e.g., an elevated heart rate and normal blood pressure) and/or as an individual biometric state.

One or more biometric states may correspond to a biometric characteristic. For example, a set of biometric states (e.g., a range of heart rates) may correspond to a particular biometric characteristic (e.g., a heart rate that is above a particular threshold). However, a biometric state may also be coextensive with a biometric characteristic. For example, both a particular biometric state experienced by a user and a particular biometric characteristic may require a biometric measurement within a particular range of values.

The user profile information may include a history of biometric states for a user and/or a current user biometric state. For example, the user profile information may include a history of biometric states (e.g., a series of data structures, each corresponding to a different biometric state a user may have experienced, with or without time stamps that indicate when the user experienced each of these biometric states) and also a current user biometric state (e.g., a pointer to one of these biometric states, indicating that that is the biometric state currently experienced by the user).

The user profile information may also include user interaction information, which may describe interactions with media assets and/or advertisements performed by a user. The user interaction information may be stored in a user interaction information database within the user profile information. Such user interaction information may include a separate information item (e.g., a separate data structure) for each individual user command that is received, such as a user command to watch a media asset, a user command to set a reminder for a media asset, a user command to store, record or download a media asset, a user command indicating a score for the media asset, a user command to search for media assets matching a keyword, a user command to display identifiers for media assets associated with a subject matter (e.g., a particular genre), or a user command to display a particular EPG screen. Each of these data structures may include information regarding the user command, such as what type of interaction it invoked, its parameters (e.g., information identifying a target media asset, search keyword, subject matter, or EPG screen), and/or the circumstances of its invocation (e.g., a current time stamp, a biometric state experienced by the user at the time the user interaction was performed and/or a user command for initiating the interaction was received, information identifying what was displayed on a screen at the time of the invocation, whether other user commands were simultaneously received).

Instead of or in combination with storing a user interaction information item for each user command, the user profile information may include interaction information in the form of a summary of a subset or all interactions performed by the user, referred to as a user interaction information summary. For example, the user profile information can alternatively or additionally include a user interaction information summary of how often a user watched or otherwise interacted with media assets of a particular genre. As another example, the user profile information may include individual information items for each user command selecting a media asset for viewing, but a user interaction information summary of all searches a user performed in the form of a list of recently used keywords. The user profile information may also include separate user interaction information summaries for different times (e.g., a separate summary for each day), for different types of interactions (e.g., a summary of media assets viewed by a user is separate from a summary of media assets recorded by a user), and/or for different biometric states experienced by the user (e.g., the user profile information may include a first user interaction information summary for interactions a user performed while experiencing a first biometric state, and a second user interaction information summary for interactions a user performed while experiencing a second biometric state).

The media guidance application may maintain a separate user profile for each individual user and/or a single user profile for all users. For example, the media guidance application may maintain a single user profile for a household and/or a separate user profile for each member of the household. The media guidance application may store user interaction information, whether by adding a new user interaction information item, by updating an existing user interaction information summary, and/or generating a new user interaction information summary, to one or more of multiple existing user profiles that are currently active. Storing to one or more user profiles may involve storing the user interaction information to a particular memory location or at a particular location within the user interactions database regardless of any user profile, and then updating user profile information associated with the one or more user profiles to link to the stored user interaction information. Additionally or alternatively, the user interaction information may be stored to one or more particular memory locations and/or data structure locations that are specifically associated with the one or more user profiles. The media guidance application may identify one or more user profiles that are active by determining which user profiles have been logged into (e.g., whether one or more users logged into their respective user profiles), based on the source of the user command that resulted in the user interaction information or other information (e.g., each user may have a separate input and/or biometric measurement device, and a received user command and/or received biometric information may include information identifying the user and/or the input and/or biometric measurement device that can then be used to identify the one or more user profiles) and/or based on the context of the user command (e.g., different user profiles are associated with different times of day and/or different genres of media assets).

It is understood that any feature that involves a user profile, user profile information and/or user interaction information may be implemented when the media guidance application maintains individual user profiles for different users, and any processing involved in such a feature may be directed at only a currently active user profile and/or all user profiles maintained by the media guidance application. For example, the media guidance application may recommend media assets based on, transmit user interaction information associated with, and/or target advertisements using only a currently active user profile and/or all user profiles maintained by the media guidance application.

As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

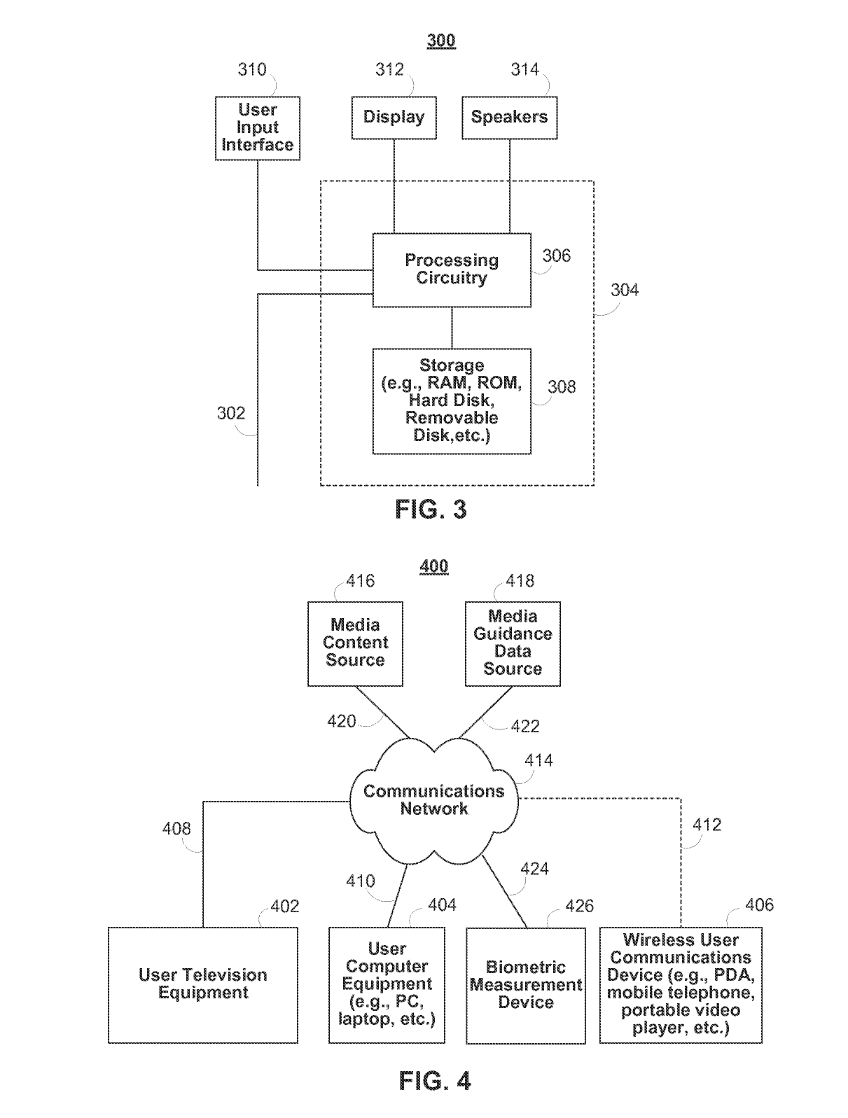

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device. System 400 may include one or more user equipment devices owned by each subscriber to services associated with media content source 416 and/or media guidance data source 418 and/or all user equipment devices capable of receiving data from media content source 416 and/or media guidance data source 418.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device. The second screen device (e.g., wireless user communications device 406) may also or alternatively or additionally transmit user commands received at the second screen device to the primary device (e.g., user television equipment 402). Accordingly, a user can interact with the second screen device to control the primary screen device, and the secondary screen device can therefore act as an alternative or addition to user input interface 310. For the sake of simplicity, and user command that is discussed as being received at user input interface 310 may also have been initially received by the second screen device and transmitted to user equipment device 300.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

System 400 may also include biometric measurement device 426. Biometric measurement device 426 may be any device that can provide biometric information, such as a heart rate monitor, glucose monitor, blood pressure monitor, thermometer, breathalyzer, EKG, and/or EEG. Biometric measurement device 426 may be a separate physical device or a component of any of user television equipment 402, user computer equipment 404, and/or wireless user communications device 406. For example, wireless user communication device 406 may be a smart watch, and biometric measurement device 426 may be a strapless heart rate monitor built into wireless user communication device 406. As another example, user input interface 310 of user television equipment 402 may be a remote control, and biometric measurement device 426 may be a heart rate monitor built into a button of user input interface 310. While only a single biometric measurement device 426 is illustrated in system 400, each user and/or user equipment device in system 400 may be associated with one or more biometric measurement devices 426. If multiple biometric measurement devices 426 are associated with a single user, each one may provide part of the received biometric information. For example, the media guidance application may receive a value for a heart rate from a heart rate monitor and a value for blood pressure from a blood pressure monitor, yet the combination of these two values may still be referred to as the received biometric information and/or indicate a single biometric state.

The user equipment devices and biometric measurement device 426 may be coupled to communications network 414. Namely, user television equipment 402, user computer equipment 404, wireless user communications device 406, and biometric measurement device 426 are coupled to communications network 414 via communications paths 408, 410, 412, and 424, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, 412, and 424 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408, 410, and 424 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices and biometric measurement device 426, these devices may communicate directly with each other via communication paths, such as those described above in connection with paths 408, 410, 412, and 426, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. For example, biometric measurement device 426 may be a heart rate monitor with a BLUETOOTH transceiver that can communicate with any of the user equipment devices, but is not coupled to communications network 414 (i.e., path 424 might not be present). The user equipment devices and biometric measurement device 426 may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, 412, and 424. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Additionally or alternatively, a third party server may also be coupled to communications network 414. The third party server may include a website or other database that is associated with media content (e.g., an Internet database of information on media assets, a website providing media asset reviews, a website that aggregates media asset reviews, a social media website and/or an online encyclopedia), but the third party server might not be affiliated with media content source 416 and/or media guidance data source 418. Although communications between sources 416 and 418 with user equipment devices 402, 404, 406, and 424 are shown as through communications network 414, in some embodiments, sources 416 and 418 may communicate directly with user equipment devices 402, 404, 406, and 424 via communication paths (not shown) such as those described above in connection with paths 408, 410, 412, and 424.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices, biometric measurement device 426, and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices and biometric measurement device 426 may communicate with each other within a home network. User equipment devices and biometric measurement device 426 can communicate with each other directly via short-range point-to-point communication schemes described above, via indirect paths through a hub or other similar device provided on a home network, or via communications network 414. Each of the multiple individuals in a single home may operate different user equipment devices on the home network, and each of the multiple individuals in a single home may have a different biometric measurement device 426. As a result, it may be desirable for various media guidance information or settings to be communicated between the different user equipment devices and/or multiple biometric measurement devices 426. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player. Additionally, user profile information for any one of the multiple individuals may include biometric information received from any one of the multiple biometric measurement devices 426, and this user profile information may be stored on or used to configure any one of the different user equipment devices within the home network.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices and biometric measurement device 426 may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

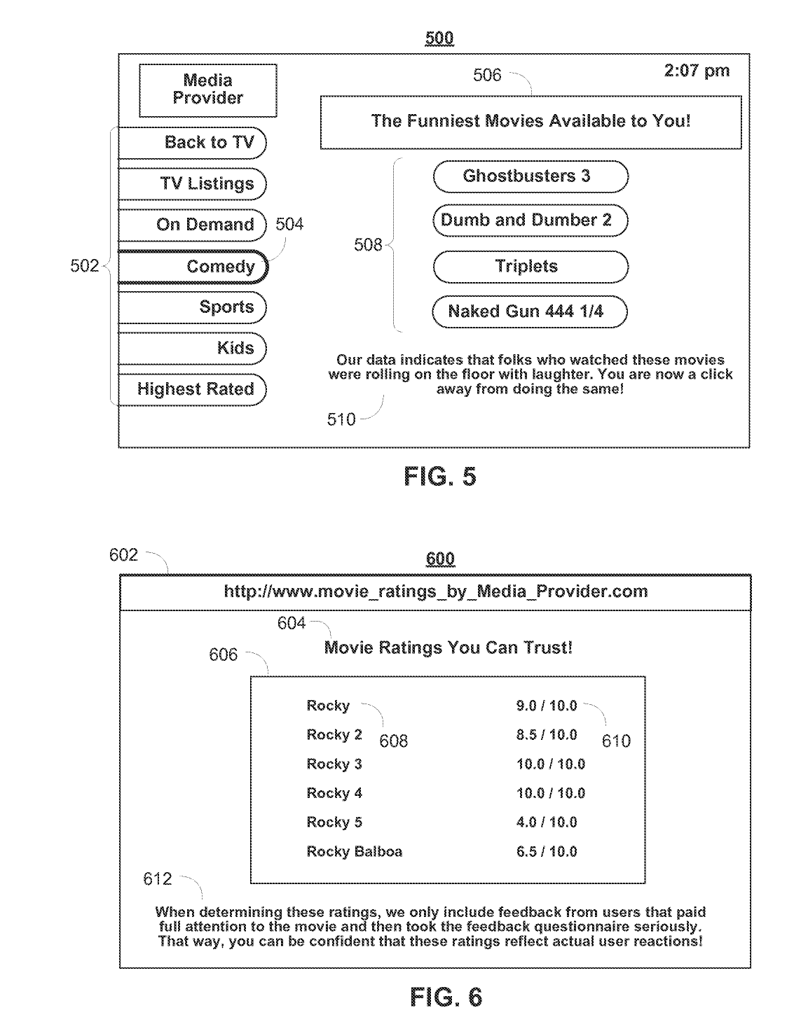

FIG. 5 shows another illustrative display, display 500, which may be generated by the media guidance application and presented on display 312. Display 500 may include selectable options 502, which may generally correspond to selectable options 202 but include selectable option 504. Display 500 may also include title 506, media identifiers 508, and description 510. The media guidance application may generate display 500 at media guidance data source 418 and transmit it to user equipment device 300, or the media guidance application may generate display 500 at user equipment device 300 based on information received from media guidance data source 418. If display 500 is generated at user equipment device 300, the media guidance application may receive the media identifiers 508, information identifying the media assets corresponding to media identifiers 508, and/or popularity information (discussed further below) for media assets corresponding to the media identifiers 508 from media guidance data source 418.

As illustrated by title 506, media identifiers 508 may correspond to media assets associated with a particular subject matter. In this example, the media assets are associated with a particular genre—comedy. However, the media guidance application may also select the media assets for whom to display media identifiers from a pool of all media assets (i.e., media identifiers 508 need not respond to media assets that are all associated with a particular subject matter). Additionally, while the media assets corresponding to media identifiers 508 are illustrated as selected from a pool of media assets available to the user (i.e., the pool of media assets that can be received from media content source 416), the media guidance application may additionally or alternatively select media assets from among all media assets known to media guidance data source 418.

The media guidance application may select the media assets corresponding to media identifiers 508 based on their popularity. This popularity may be determined based on popularity information, which may include information on real time ratings (e.g., how many users are watching this media asset at this time), past ratings (e.g., how many users have previously watched this media asset by either receiving it from media content source 416 or by watching it from another source, such as in a movie theatre), ratings (e.g., a combination of both or either one of real time ratings and past ratings), critic scores, user scores, and/or user reactions. Popularity information may be received by media guidance data source 418 and/or user equipment device 300 from the third party server (e.g., a ratings website or other source of information associated with media assets) and/or media guidance data source 418 may collect the popularity information by collecting user interaction information from some or all user equipment devices in system 400 (e.g., the media guidance data source 418 may generate past ratings by collecting user interaction information on how often a particular media asset has been watched by users of system 400 and/or transmitted to user equipment devices in system 400). For example, media guidance data source 418 may receive past ratings from a third party server (e.g., the media guidance application may download box office results of a media asset from a website), receive user scores from user equipment devices, and use both sets of information to select the media assets corresponding to media asset identifiers 508.

As explained by description 510, the media guidance application might only consider user interaction information associated with a particular biometric characteristic when selecting the media assets corresponding to media identifiers 508. This may involve having the media guidance application only consider information on interactions a user performed while experiencing a biometric state corresponding to the particular biometric characteristics. For example, the media guidance application may use popularity information to determine the most often watched program when a user experiences a particular biometric characteristic. In another example, the media guidance application may use popularity information to identify programs whose viewers had the highest probability of experiencing a particular biometric characteristic. The media guidance application may select the particular biometric characteristic based on a user selection of selectable option 504.

The media guidance application may have selected the media assets corresponding to media identifiers 508 based on user interaction information that indicated that users who interacted with these media assets were experiencing a biometric state associated with laughter at the time of these interactions. The media guidance application may identify these media assets as the best comedies. In other examples, the media guidance application may identify the best thrillers or horror media assets based on user interaction information that indicated that users who interacted with these media assets were experiencing a biometric state associated with fear at the time of the interactions, may identify the best dramas based on user interaction information that indicated that users who interacted with these media assets were experiencing a biometric state of sadness at the time of the interactions, and/or may identify the best action media assets based on user interaction information that indicated that users who interacted with these media assets were experiencing a biometric state of excitement at the time of the interactions.

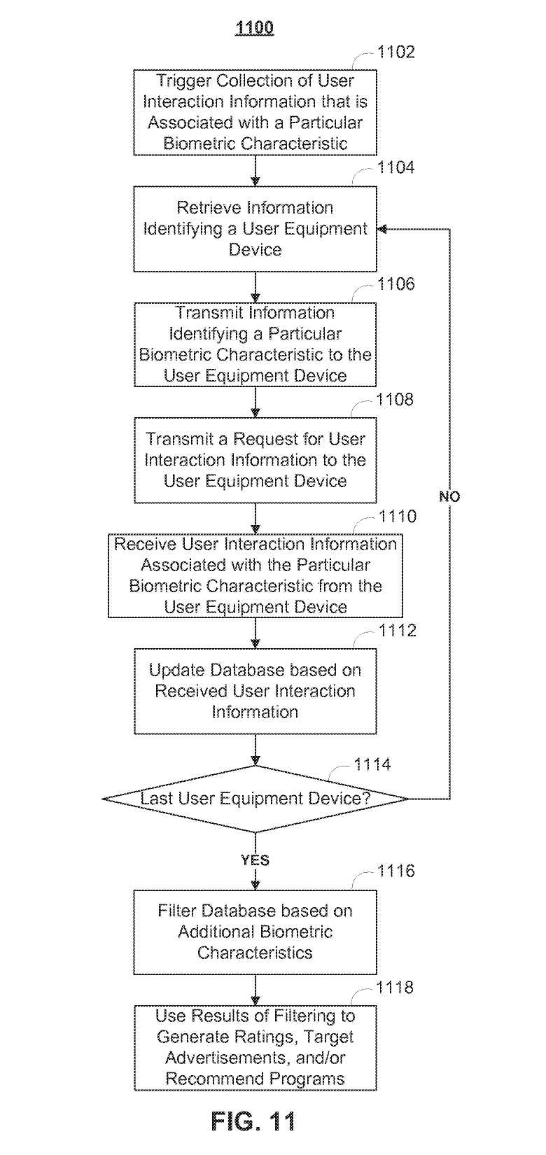

As will be discussed in further detail below in reference to FIG. 11, the media guidance application might consider only user interaction information associated with a particular biometric characteristic by having media guidance data source 418 collect only user interaction information pertaining to interactions a user performed while experiencing a biometric state corresponding to the particular biometric characteristic, or by having media guidance data source 418 collect all user interaction information and then process the collected information to filter out user interaction information not associated with interactions a user performed while experiencing a biometric state corresponding to the particular biometric characteristic.

FIG. 6 shows another illustrative display, display 600, which may be generated by the media guidance application and presented on display 312. Display 600 may be of website 602 and include title 604, media asset scores area 606, and description 612. Within media asset scores area 606, display 600 may indicate that media asset 608 has a score of 610. The media guidance application may calculate score 610 as a direct or weighed average of user interaction information collected by media guidance data source 416 from some or all user equipment devices of system 400 that indicates user inputted scores for media asset 608.

As explained in description 612, the media guidance application may calculate score 610 by only taking into consideration or by weighing more heavily user scores for media asset 608 received from users who were experiencing a biometric state corresponding to a particular biometric characteristic when interacting (e.g., viewing or selecting for viewing) with media asset 608 or from users who were experiencing a biometric state corresponding to the particular biometric characteristic when inputting their user scores. The particular biometric characteristic may be associated with focus, and calculated score 610 may therefore be more reliable, since it is based on user scores inputted by focused users.

The media guidance application may generate display 600 for display on a user equipment device that is also capable of receiving media asset 608 and/or from which media guidance data source 418 collects user interaction information, and/or for display on a user equipment device that is not part of system 400, that is unable to receive media asset 608, and/or from which media guidance data source 418 does not collect user interaction information.

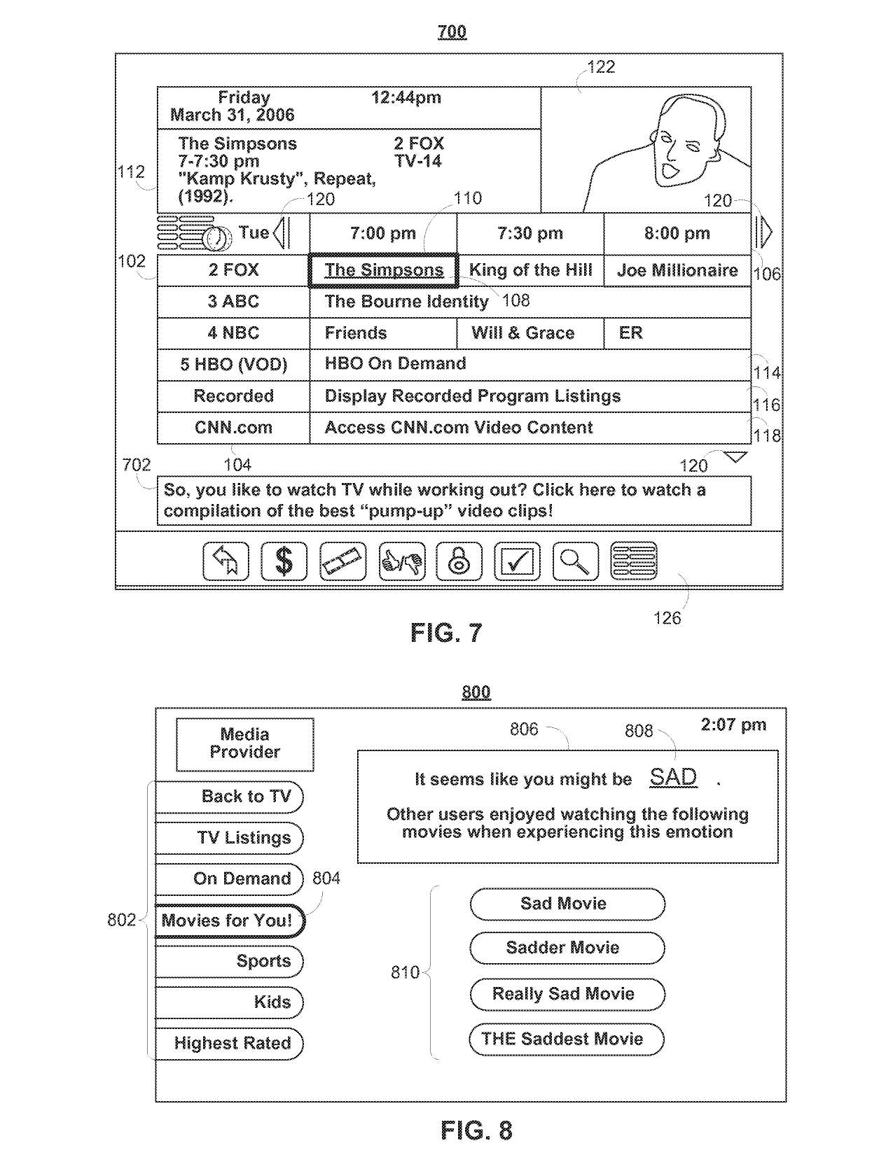

FIG. 7 shows another illustrative display, display 700, which may be generated by the media guidance application and presented on display 312. In general, display 700 generally corresponds to display 100 of FIG. 1. However, the media guidance application may target advertisement 702 based on a biometric state currently experienced by a user of user equipment device 300.

An advertiser may specify one or more biometric characteristics to be associated with each advertisement. Alternatively or in combination, the media guidance may determine biometric states corresponding to one or more biometric characteristics users experienced while interacting with the advertisement and/or paying for an advertised product or media asset. These one or more biometric characteristics may be stored together with or separately from the advertisement in an advertisement library. When the media guidance application retrieves an advertisement from the advertisement library for display, the media guidance application may compare the biometric state currently experienced by the user with the one or more biometric characteristics, and, if the biometric state corresponds to any one of these biometric characteristics, select the associated advertisement for display.

FIG. 8 shows another illustrative display, display 800, which may be generated by the media guidance application and presented on display 312. Display 800 may include selectable options 802, which may generally correspond to selectable options 202 but include selectable option 804. Display 800 may also include caption 806, current user biometric state 808, and media asset identifiers 810 corresponding to media assets recommended for the user.

The media guidance application may determine current user biometric state 808 and use this information to identify the recommended media assets corresponding to media asset identifiers 810. The media assets may be media assets other users in system 400 most frequently interacted with (e.g., viewed or selected for viewing) when these other users were experiencing the same or a similar biometric state, media assets other users in system 400 gave high scores to while experiencing the same or a similar biometric state and/or after viewing the media assets while experiencing the same or a similar biometric state, or media assets for which the corresponding media guidance data indicates that the media assets are associated with the same or a similar biometric state (e.g., media assets belonging to a genre commonly associated with current user biometric state 808).

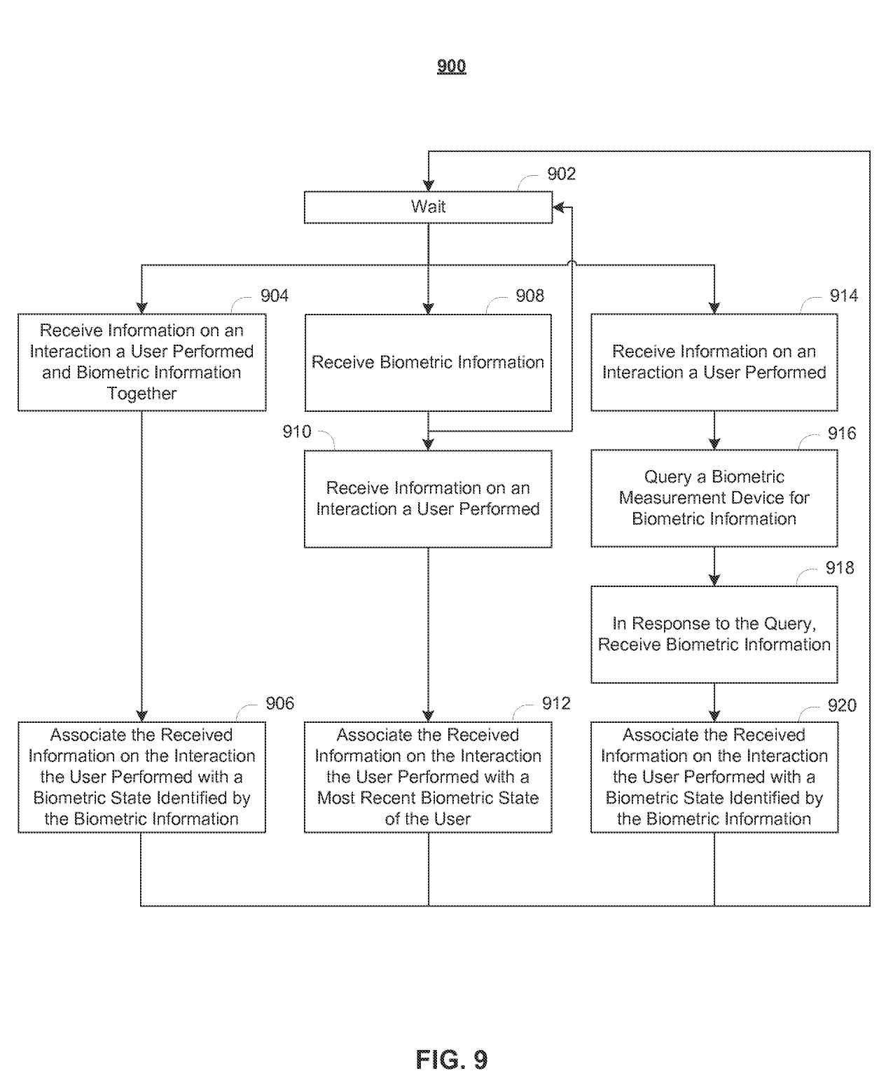

FIG. 9 illustrates process 900 for associating a biometric state with information on interactions a user performed while experiencing the biometric state. Process 900 may be performed by an instance of the media guidance application running on user equipment device 300.

At step 902, the media guidance application waits for the user to perform an interaction, which may be indicated by receipt of a user command. This may involve waiting for an interrupt to wake up a thread, performing other calculations until a particular location within the flow of the software used to implement the media guidance application, waiting until a message containing particular information is received and/or waiting until a set timer expires.

Depending upon implementation, the media guidance application may perform one or more of steps 904-906, steps 908-912, and/or steps 914-916. For example, the media guidance application might only query a biometric measurement device for biometric information in response to receiving a user command, as discussed below in reference to steps 914-920. In another example, the media guidance application may query a biometric measurement device for biometric information in response to receiving a user command, as discussed below in reference to steps 914-920, but may also periodically receive biometric information, as discussed below in reference to steps 908-912, and/or only query the biometric measurement device if the media guidance application determines that biometric information is not received together with the user command, as discussed below in reference to steps 904-906. In a third example, the media guidance application may receive some of the biometric information from a first biometric measurement device (e.g., a heart rate monitor) using any one of steps 904-906, steps 908-912, or steps 914-916 and receive biometric information from a second biometric measurement device (e.g., a blood glucose monitor) using any other one of steps 904-906, steps 908-912, or steps 914-916.

If the media guidance application performs steps 904-906, the media guidance application may receive information on an interaction a user performed and biometric information together at step 904. This may involve receiving a single message from user input interface 310 that includes both a data structure with information on the interaction the user performed (e.g., information identifying a received user command) and a data structure containing the biometric information. The information on an interaction a user performed may indicate a user command that requires calling a function, include information identifying the function (e.g., a “tune to” function), include parameters with which the function is to be called (e.g., a user selected channel which is to be tuned to), include information on circumstances of the user interaction (e.g., a time stamp associated with when the interaction was performed or the user command received), and/or indicate that the user interaction was already performed. As such, the media guidance application may actually perform the interaction identified by the received information (e.g., cause user equipment device 300 to tune to the selected channel) or only store information on an interaction that was already performed.

The media guidance application may also receive two or more separate messages—one identifying the received user command and one or more containing the biometric information—but the two or more messages may be temporally related. For example, media guidance application may receive the two or more messages substantively simultaneously, one immediately after the other, and/or in a predefined order (e.g., biometric information from a first biometric measurement device may be received immediately before the user command, and biometric information from a second biometric measurement device may be received three messages after the user command). It is also possible that some biometric information is received in the same message as the user command, while additional biometric information is received in a separate message. For example, the media guidance application may receive biometric information from a first biometric measurement device in the same message as the information on the interaction the user performed while experiencing the biometric state and biometric information from a second and/or third biometric measurement device in one or two separate additional messages.

The media guidance application may perform step 904 if user input interface 310 also includes biometric measurement device 426. For example, user input interface 310 may be a remote control that also obtains a user's heart rate when the user depresses a button by incorporating a heart rate monitor into the button itself. Alternatively or in combination, user input interface 310 may automatically query biometric measurement device 426 for biometric information, and then transmit the information on the interaction the user performed and the biometric information together. For example, wireless user communications device 406 may be configured to act as a second screen device for controlling user television equipment 402. In response to receiving a user command for controlling user television equipment 402, wireless user communications device 406 may first query biometric measurement device 426 for biometric information using a direct path (e.g., a BLUETOOTH connection) and then transmit both the user command and the biometric information together to user television equipment 402.

At step 906, the media guidance application may associate the received information on the interaction the user performed with the received biometric information. This may involve storing the received information on the interaction the user performed to the user profile information in a manner that makes it possible to later determine what biometric state (as indicated by the received biometric information) the user experienced while performing the interaction. The media guidance application may generate and store a single user interaction information item that includes both the received information on the interaction the user performed and the received biometric information and/or update and/or create a user interaction information summary based on both the received information on the interaction the user performed and the received biometric information.

Alternatively or in combination, the media guidance application may generate a user interaction information item that includes the information on the interaction the user performed and/or update and/or create a user interaction information summary based on the information on the interaction the user performed and separately update the history of user biometric states by appending a new biometric state based on the received biometric information and/or update a current user biometric state by replacing the previous biometric state with a new biometric state based on the received biometric information. If the media guidance application maintains a history of user biometric states, the media guidance application may consider the most recently added biometric state to be the current user biometric state.

Alternatively or in combination, the media guidance application may use the received biometric information to select a location within a user interactions database to store a newly generated user interaction information item that includes the information on the interaction the user performed and/or to select a user interaction information summary to update based on the information on the interaction the user performed. For example, each location within the user interactions database and/or each user interaction information summary may be associated with a different biometric state a user may have experienced while performing the interactions, and the biometric information may be matched against these potential biometric states to select a location within the user interactions database and/or a user interaction information summary that is associated with the biometric state the user experienced when the user performed the interaction.

Alternatively or in combination, instead of using the biometric information to select a location within the user interactions database and/or a user interaction information summary, the user interaction information item that includes the information on the interaction the user performed may be stored at a location within the user interactions database and/or a user interaction information summary may be updated based on the information on the interaction the user performed regardless of the received biometric information. However, the biometric information may then be used to add a link to the recently generated user interaction information item and/or recently updated user interaction information summary to a data structure that is selected based on the biometric information and that is associated with a biometric state identified by the biometric information. For example, the media guidance application may maintain a data structure of links to user interaction information for each of a number of different biometric states a user may experience and/or may store links to user interaction information in the history of biometric states discussed below.

If the media guidance application performs steps 908-912, the media guidance application may receive biometric information from biometric measurement device 426 at step 908. The biometric information may be received periodically and/or regardless of user interactions. For example, biometric measurement device 426 may automatically periodically transmit biometric information and/or the media guidance application may automatically periodically query biometric measurement device 426 for biometric information. The periodicity of the receipt of the biometric information may be based on the passage of time (e.g., the biometric information may be received every certain number of seconds) or based on a location in the media guidance application's software flow (e.g., the biometric information may be received every time after the media guidance application's background processing performs a particular action). While receipt of the biometric information may be automatic (i.e., is not performed responsive to user input), the periodicity of the receipt may be affected by user interactions. For example, if a user is actively interacting with the media guidance application, the media guidance application's background processing may need to perform additional tasks or may be slowed down due to the need to share resources with an active thread, so the particular action performed by the background processing that triggers the receipt of the biometric information may be performed less frequently. In another example, if the media guidance application is trying to conserve battery life, the media guidance application may query biometric measurement device 426 less frequently for biometric information.

As part of step 908, the media guidance application may update a history of user biometric states by appending a new biometric state based on the received biometric information and/or update a current user biometric state by replacing the previous biometric state with a new biometric state based on the received biometric information.

Between the periodic receipts of the biometric information, the media guidance application may continue to wait at step 902 for further biometric information and/or information on an interaction a user performed.

At step 910, the media guidance application may receive information on an interaction the user performed.

At step 912, the media guidance application may associate the received information on the interaction the user performed with the most recent biometric state of the user. The most recent biometric state of the user may correspond to the current user biometric state maintained by the media guidance application. The media guidance application may also compare a timestamp associated with the receipt of the information on the interaction the user performed with a time stamp associated with each biometric state of the history of user biometric states (e.g., a time stamp indicating when the biometric information used to identify each biometric state was received and/or a time stamp indicating when the biometric state was added to the history), and associate the information on the interaction the user performed with the biometric state the user experienced immediately prior to the user interaction, immediately after the user interaction, or closest in time to the user interaction.

Once a biometric state has been identified, the media guidance application may update the user profile information in the same manner as discussed above in reference to step 906.

If the media guidance application performs steps 914-920, the media guidance application may receive information on an interaction the user performed at step 914.

At step 916, the media guidance application may receive information on an interaction a user performed.

At step 918, the media guidance application may query one or more biometric measurement devices 426 for biometric information. The biometric measurement device 426 may be identified as biometric measurement devices associated with a currently active profile, all biometric measurement devices 426 currently in communication with user equipment device 300, and/or only biometric measurement devices 426 for which user inputted identifying information is stored. Additionally or alternatively, the media guidance application may query the user to input information identifying any available biometric measurement devices. For example, the media guidance application may store in a user profile of each user information identifying one or more biometric measurement devices 426 associated with that user. This information may have been inputted by the user in response to a query displayed when the user profile was initially set up, when the user was logging in to the profile, and/or when the media guidance application was unable to query any measurement devices 426. At step 916, the media guidance application may query a home network to identify all biometric measurement devices 426 currently in communication with user equipment device 300 and select which biometric measurement devices 426 to query by comparing the identified biometric measurement devices 426 with information identifying biometric measurement devices associated with a currently active user retrieved from the currently active user profile.

Alternatively or in combination, each biometric measurement device 426 may require a user to log in to a user profile associated with biometric measurement device 426, and the media guidance application may compare the user profile active on user equipment device 300 with the user profile active on biometric measurement device 426 to determine if the two devices are associated with the same user.

Once one or more biometric measurement devices 426 have been selected, the media guidance application may transmit a request for biometric information to each one of them. In response to these requests and/or queries, the media guidance application may receive biometric information from each of one or more biometric measurement devices 426. Alternatively or in combination, after the media guidance application has selected biometric measurement devices 426 to be queried, the media guidance application may also be able to just read the biometric information from a register accessible to user equipment device 300. For example, biometric measurement device 426 may be a component of user equipment device 300, and the media guidance application may be able to simply read the biometric information from a register of this component.

At step 920, the media guidance application may associate the received information on the interaction the user performed with a biometric state identified by the received biometric information. This may involve steps similar to those discussed above in reference to step 906, but using the biometric information the media guidance application received at step 918 in response to the query.

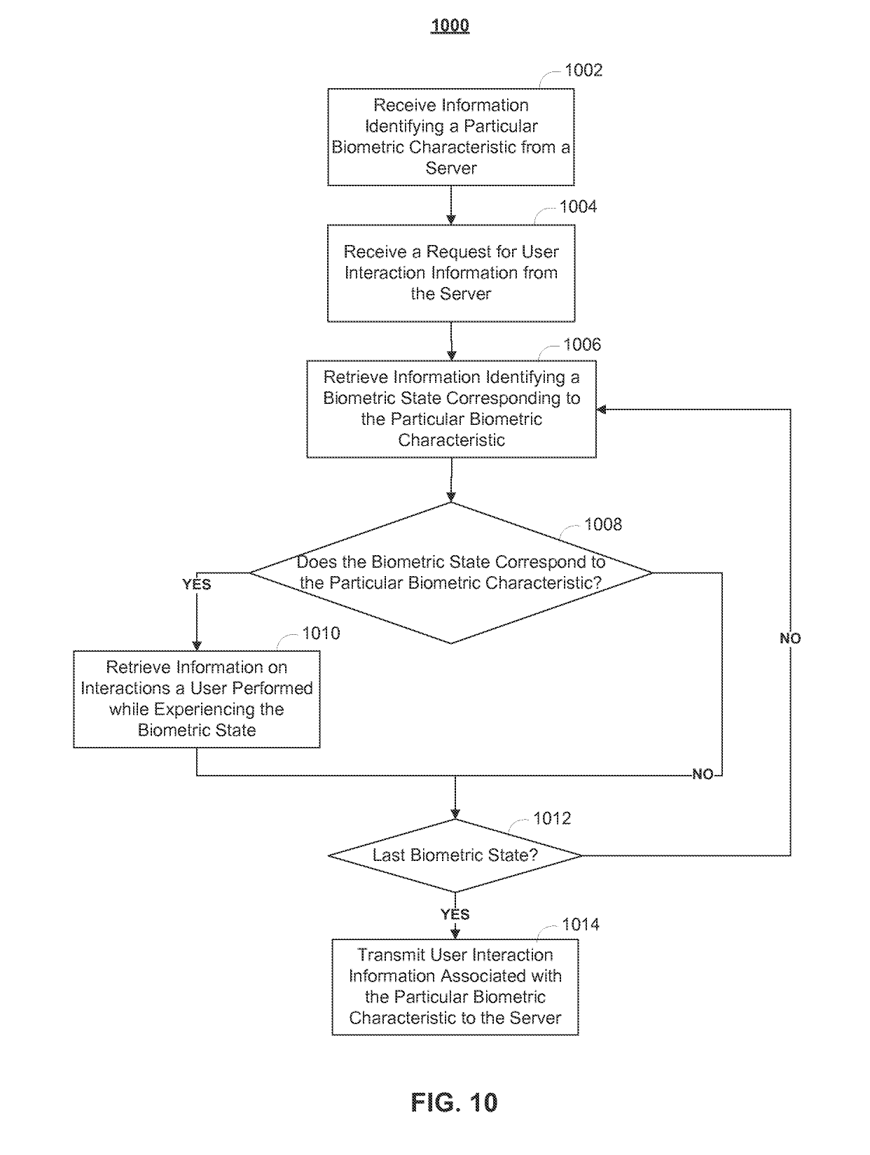

FIG. 10 illustrates process 1000 for transmitting user interaction information that is associated with a particular biometric characteristic to a server (e.g., media guidance data source 418, media content source 416, or a third party server). Process 900 may be performed by an instance of the media guidance application running on user equipment device 300.

At step 1002, the media guidance application may receive information identifying a particular biometric characteristic from the server. This information may include one or more values and/or ranges of values for one or more biometric measurements, and/or one or more identifiers that allow the media guidance application to retrieve one or more values and/or ranges of values for one or more biometric measurements. The values and/or ranges of values may be in absolute terms, may be relative to an average for a user that the media guidance application can determine based on a stored history of biometric states for the user and/or a separately maintained variable, and/or may be relative to a maximum for a user that the media guidance application can determine based on a stored history of biometric states for the user and/or a separately maintained variable. Values and/or ranges of values for different biometric measurements may be identified using any combination of these methods.

The media guidance application may receive the information identifying the particular biometric characteristic as a message from the server. The information may be directly used to retrieve and transmit user interaction information and/or stored in storage 308 for later use. Alternatively or in combination, the information identifying the particular biometric characteristic may be part of the software that implements the media guidance application. For example, the particular biometric characteristic may be defined when the media guidance application is first installed and/or only updated when the media guidance application itself is being updated.

The media guidance application might also not receive any information identifying a particular biometric characteristic. This may be the case for all user equipment devices in system 400 (e.g., the server may not yet have transmitted the information to any user equipment devices, or the media guidance application might not be configured to use the information), or only a subset thereof (e.g., the server may transmit information identifying the particular biometric characteristic periodically, and some user equipment devices may not yet have received the information and/or may not have updated the software of their media guidance application). In either of these cases, the media guidance application may still perform process 1000, but might transmit all user interaction information or only user interaction information associated with any biometric state. For example, the media guidance application may transmit all user interaction information that it was able to associate with a biometric state and/or that is associated with a user profile for a user who also has at least one biometric measurement device 426 and/or with a user profile that includes information identifying at least one biometric measurement device 426.

At step 1004, the media guidance application may request a request for user interaction information from the server. This request may be part of the same message that includes the information received at step 1002 (e.g., the media guidance application may receive a single request for user interaction information associated with the particular biometric characteristic) or may be received as a separate message. For example, the media guidance application may receive a first message at step 1002 that contains information identifying the particular biometric characteristic, and later receive a second message at step 1004 that requests the user interaction information. The first and second messages may be received in quick succession one after the other (e.g., the server first sets the particular biometric characteristic and then immediately requests user interaction information associated with this biometric characteristic) or the timing of the receipt of these two messages may be independent (e.g., the server first set the particular biometric characteristic, the media guidance application stores the particular biometric characteristic for later use, and the server requests the user interaction information associated with this biometric characteristic at a later time).

While only a single receipt of information identifying a particular biometric characteristic and a single receipt of a request for user interaction information is shown in FIG. 10, this need not be the case. In fact, there need not be a one-to-one relationship between step 1002 and 1004. For example, the media guidance application may receive information identifying the particular biometric characteristic periodically or in response to a user selection at the server (e.g., only with a software update for the media guidance application or in response to a user input selecting the particular biometric characteristic received from a user of the server), and receive the request for user interaction information more frequently (e.g., daily). In another example, the media guidance application may receive information specifying multiple biometric characteristics, either in a single message received at step 1002 or in multiple separate messages received at different times and accumulated by the media guidance application.

Additionally or alternatively, the media guidance application may perform the rest of process 1000 even without step 1004. For example, the media guidance application may transmit user interaction information automatically at particular times, every time the media guidance application receives information on an interaction the user performed, and/or as part of a process for logging out of a user profile and/or turning off the system.

At step 1006, the media guidance application may retrieve information identifying a biometric state. This may involve retrieving information identifying a biometric state from the history of biometric states, retrieving information identifying a biometric state from a data structure of links to user interaction information associated with the biometric state, retrieving information identifying a biometric state from a user interaction information summary, and/or retrieving information identifying a biometric state from a user interaction information item that is associated with the biometric state.

At step 1008, the media guidance application may determine whether the biometric state identified by the retrieved information corresponds to the particular biometric characteristic. This may involve comparing the information to the information received at step 1002 to determine if it is an exact match (e.g., the particular biometric characteristic and the biometric state may be coextensive), to determine if the biometric state matches one or more values and/or falls within one or more ranges of values specified by the particular biometric characteristic, and/or to determine if the biometric characteristic matches one or more values and/or falls within one or more ranges of values specified by the particular biometric state.

The media guidance application may also select an appropriate one or more values and/or ranges of values based on a look-up table. For example, the media guidance application may receive at step 1002 only information specifying that the particular biometric characteristic is “laughter,” and, based on this information, retrieve one or more values and/or ranges of values for one or more biometric measurements that correspond to “laughter.” The look-up table may be received as a separate message from the server, may be received at step 1002 and/or 1004, may be part of the software that implements the media guidance application, and/or may be received as part of an update of the software that implements the media guidance application.

The information received at step 1006 and/or received using the look-up table may specify multiple sets of one or more values and/or ranges of values for one or more biometric measurements. For example, the particular biometric characteristic of “laughter” may be identified using either a particular range of serotonin levels and/or a particular range of heart rates coupled with a particular range of breathing rates. In that case, the media guidance application may compare the information retrieved at step 1006 against each of these multiple sets and determine that the biometric state identified by the information retrieved at step 1006 corresponds to the particular biometric characteristics if the information retrieved at step 1006 matches any one of these sets.

If the media guidance application determines at step 1008 that the biometric state identified by the information retrieved at step 1006 corresponds to the particular biometric characteristic, the media guidance application may retrieve at step 1010 information on interactions the user performed while experiencing the biometric state. This may involve retrieving user interaction information stored in the same data structure as the information retrieved at step 1006 and/or retrieving user interaction information based on a link stored in the same data structure as the information retrieved at step 1006. The retrieved information may consist of one or more user interaction information items and/or one or more user interaction information summaries

The media guidance application may also perform step 1010 without performing steps 1006 and 1008. For example, the information received at 1002 may include a link to user interaction information that is to be transmitted or otherwise specify a particular set of user interaction information that is to be transmitted. For example, the media guidance application may maintain an array of pointers to user interaction information and/or an array of the user interaction information itself, and the media guidance application may receive at step 1002 information identifying one or more indexes of either of these arrays. In this case, the media guidance application may be able to retrieve and transmit user interaction information without having to retrieve information identifying any biometric state and comparing the biometric state to the particular biometric characteristic.

At step 1012, the media guidance application may determine whether the biometric state identified by the information retrieved at step 1006 is the last biometric state. For example, the media guidance application may determine if any further information on biometric states can be retrieved in the manner discussed above in reference to step 1006. If it cannot, the media guidance application may determine that this is the last biometric state and proceed to step 1014. If the media guidance application determines at step 1012 that this is not the last biometric state, the media guidance application returns to step 1006 and retrieves the further information identifying the next biometric state. If the particular biometric characteristic is coextensive with the biometric state, and no further biometric states can therefore correspond to the particular biometric characteristic, the media guidance application may skip step 1012 and assume that this is the last biometric characteristic.

The media guidance application may also process multiple use profiles using steps 1006-1012 in response to a receiving a single request for user interaction information at step 1004 and/or in response to any of the automatic triggers discussed above for situations when the user interaction is transmitted even in the absence of such a request. The media guidance application may perform steps 1008-1012 for all currently active user profiles, only for user profiles that include information identifying biometric measurement devices 426, only for user profiles that include a permission to transmit user interaction information, for all user profiles maintained by the media guidance application, and/or for any user profiles specified in a message received as part of step 1002 and/or step 1004. Additionally or alternatively, user interaction information for all user profiles that is associated with a biometric state may be stored together, so that the media guidance application may retrieve user interaction information for all user profiles at a single iteration of step 1010.

If the media guidance application received information identifying multiple biometric characteristics from the server, the media guidance application may repeat steps 1006-1012 for each one of these biometric characteristics. This may involve performing all of steps 1006-1012 for each one of these biometric characteristics separately (e.g., the media guidance application may first perform steps 1006-1012 for a first biometric characteristic, and then perform steps 1006-1012 for a second biometric characteristic) or by performing steps 1006 and 1012 only once for all biometric characteristics, but then performing steps 1008 and 1010 separately for each biometric characteristic. The media guidance application may also first iterate across all user profiles before moving on to the next biometric characteristic, or first iterate across all biometric characteristics before moving on to the next user profile.

At step 1014, the media guidance application may transmit user interaction information associated with the particular biometric characteristic to the server. The media guidance application may accumulate all information retrieved at step 1010 and transmit it in a single batch, process the information retrieved at step 1010 to generate a user interaction information summary for transmittal, transmit the information retrieved at step 1010 for each user profile separately, and/or transmit the information retrieved at each iteration of step 1010 separately. Additionally or alternatively, the media guidance application may transmit the information retrieved at step 1010 to the server as it is retrieved (e.g., as part of step 1010).

FIG. 11 illustrates process 1100 for selectively collecting user interaction information associated with a particular biometric characteristic from a user equipment device. Process 1100 may be performed by an instance of the media guidance application or any other application running on the server referenced in relation to process 1000 of FIG. 10. Process 1100 need not be performed by the same instance of an application or even by the same application as the instance of the media guidance application that performs process 1000 of FIG. 10. However, for the sake of simplicity, process 1100 will be discussed as being performed by the media guidance application.

At step 1102, the media guidance application may trigger collection of user interaction information that is associated with a particular biometric characteristic. The media guidance application may perform step 1102 in response to an input from a user of the server (e.g., an employee of a provider of the media guidance application), at a particular time (e.g., once a day, week or month), and/or in response to a selection received from a user equipment device in system 400 (e.g., in response to receiving an indication of a user selection of selectable option 504).

The media guidance may select the particular biometric characteristic based on a user selection (e.g., based on a user selection of selectable option 504), based on an input of a user of the server, and/or may always employ the same default biometric characteristic. For example, the media guidance application may always only collect user interaction information associated with biometric states that indicate that the user paid attention to the media asset the user interacted with.

At step 1104, the media guidance application may retrieve information identifying a user equipment device, such as user equipment device 300, in system 400. The server may query communications network 414 to identify user equipment devices in system 400, may receive registration information from user equipment devices in system 400, and/or may store information identifying user equipment devices in system 400. The retrieved information may include an IP address, communications protocol, registration information that may be used to retrieve additional information on the user equipment device, and/or information indicating whether the server has permission to collect user interaction information from the user equipment device.

The media guidance application might collect only user interaction information that is associated with a biometric state of the user. The media guidance application may, for example, only maintain information identifying user equipment devices whose users are also associated with one or more biometric measurement devices 426 or mark information identifying such user equipment devices so only information identifying a user equipment device whose users are also associated with one or more biometric measurement devices might be retrieved at step 1104. Alternatively or in combination, the media guidance application may, after retrieving information identifying a user equipment device, first query the user equipment device and have the user equipment device respond with information indicating whether the user interaction information maintained by the user equipment device is associated with at least one biometric state. Alternatively in combination, the media guidance application may query one or more biometric measurement devices 426, requesting information identifying any user equipment devices that are associated with these biometric measurement devices 426 and that therefore may store user interaction information that is associated with at least one biometric state for the user. The media guidance application may also receive biometric information identifying a biometric state currently experienced by a user in response to querying the one or more biometric measurement devices 426. The media guidance application may then retrieve information identifying only those user equipment devices in system 400 whose users are currently experiencing a biometric state corresponding to the particular biometric characteristic.

At step 1106, the media guidance application may transmit information identifying a particular biometric characteristic to user equipment device 300 using the information retrieved at step 1104. The transmitted information corresponds to the information received by user equipment device 300 at step 1002 of FIG. 10.

At step 1108, the media guidance application may transmit a request for user interaction information to user equipment device 300 using the information retrieved at step 1104. The transmitted request corresponds to the request received by user equipment device 300 at step 1004 of FIG. 10.

At step 1110, the media guidance application may receive user interaction information associated with the particular biometric characteristic from the user equipment device. The received user interaction information may correspond to the user interaction information transmitted by user equipment device 300 at step 1014 of FIG. 10.

At step 1112, the media guidance application may update a user interactions database maintained at the server based on the user interaction information received at step 1110. The media guidance application may store the user interaction information received from the user equipment device to the user interactions database without further processing or may use the received user interaction information to update user interaction information summaries maintained that are stored in the user interactions database. The media guidance application may store the received user interaction information in a manner that continues to associate the received user interaction information with the biometric state the user experienced when performing the interaction the received information pertains to and/or may associate the received user interaction information with the particular biometric characteristic. The media guidance application may organize the user interactions database at the server in a similar manner as the user profile information discussed in reference to steps 906, 912, and/or 920 of FIG. 9 that is stored by user equipment device 300, but using a larger database that is capable of storing user interaction information accumulated by all user equipment devices in system 400.

At step 1114, the media guidance application may determine if user equipment device 300 is the last user equipment device in system 400 that needs to be processed. This may involve repeating step 1104 one more time to determine if information identifying another user equipment device can be retrieved. If the media guidance application determines that such information is available, and that user equipment device 300 is therefore not the last user equipment device, the media guidance application may return to step 1104 and retrieve information identifying the next user equipment device. If the media guidance application determines that such information is not available, and that user equipment device 300 is therefore the last user equipment device, the media guidance application may proceed to step 1116.

Instead of transmitting information identifying a particular biometric characteristic and a request for user interaction information to a single user equipment device, and then repeating steps 1104-1112 multiple times, the media guidance application may also retrieve information identifying multiple user equipment devices at step 1104, and then transmit the biometric characteristic identifying information (step 1106) and/or the request (step 1108) to all identified user equipment devices before proceeding to the next step. This may be done by transmitting the biometric characteristic identifying information and/or the request to each identified user equipment device individually, by multicasting the biometric characteristic identifying information and/or the request to the identified user equipment devices, by broadcasting the biometric characteristic identifying information and/or the request to all user equipment devices in system 400, but including a field in the biometric characteristic identifying information and/or the request so that only the identified user equipment devices transmit user interaction information, and/or by broadcasting the biometric characteristic identifying information and/or the request to all user equipment devices in system 400, and having all user equipment devices in system 400 transmit user interaction information.

At step 1116, the media guidance application may further filter the user interactions database based on additional biometric characteristics. This may involve retrieving user interaction information that is associated with a biometric state corresponding to the additional biometric characteristic in the manner discussed above in reference to FIG. 10. The retrieved information may then be used to populate a new database of user interaction information, to generate new user interaction information summaries, to replace the user interactions data, and/or as input to step 1118 with or without additional information from the user interactions database. The media guidance application may skip step 1116 if it determines that no additional filtering is necessary. Alternatively or in combination, the media guidance application may collect all user interaction information available in system 400 when updating the database at step 112, and the user interaction information collected by the media guidance application may therefore not have been filtered based on a particular biometric characteristic as part of the collection process. In this case, step 1112 may be the only filtering performed by the media guidance application based on biometric characteristics. The media guidance application may select the additional biometric characteristics used to filter the user interactions database in any of the manners discussed above in reference to selecting the particular biometric characteristic at step 1102.

At step 1118, the media guidance application may use the results of the filtering performed at step 1116 and/or information stored in the user interactions database to generate ratings, target advertisements and/or recommend programs. This may involve generating any of the popularity information discussed above. For examples, the media guidance application may use the results of the filtering or the information stored in the user interactions database to calculate real time or past ratings for a media asset among users who viewed or otherwise interacted with the media asset while experiencing a biometric state corresponding to the particular and/or the additional biometric characteristic (e.g., focus, laughter, fear, and/or excitement), to identify media assets that most frequently elicit a biometric state corresponding to the particular and/or additional biometric characteristic in users interacting with the media assets, and/or to calculate an average score for a media asset that only considers or weighs more heavily scores inputted by users experiencing a biometric state corresponding to the particular and/or the additional biometric characteristic. Such popularity information may be used by the media guidance application to select the media assets corresponding to media identifiers 508 and/or to generate display 500. Alternatively or in combination, the calculated average scores for media assets may be sorted and/or directly displayed to the user, such as score 610 in display 600.

Alternatively or in combination, the media guidance application may use the results of the filtering and/or the information stored in the user interactions database to identify biometric states corresponding to the particular and/or additional biometric characteristic that users experienced when interacting with an advertisement and/or when paying for a product or media asset advertised by the advertisement. The media guidance application may then use this information to target a particular advertisement to users who are experiencing the same or similar biometric states as the users who interacted with the particular advertisement and/or paid for a product or media asset advertised by the particular advertisement. For example, the media guidance application may use such information to select advertisement 702 when generating display 700.

Alternatively or in combination, the media guidance application may use the results of the filtering and/or the information stored in the user interactions database to select media assets that were given high scores and/or frequently viewed or otherwise interacted with by users experiencing each of a number of different biometric states. This information may then be used by the media guidance application to identify recommended media assets, such as the media assets corresponding to media asset identifiers 810, for display to a user when the user is experiencing one of the number of different biometric states, such as in display 800.

While user interaction information not associated with a particular and/or additional biometric characteristic has generally been described as being filtered out and/or not collected, any of the processing discussed herein can equally just discount user interaction information not associated with the particular and/or additional biometric information instead of not relying on it. For example, the media guidance application may determine for each user interaction how closely a biometric state the user experienced while performing the interaction corresponds to the particular and/or additional biometric characteristic and weigh the user interaction accordingly. For example, when calculating real time or past time ratings, instead of counting each user who viewed a particular media asset equally, the media guidance application may count a user who viewed the media asset while experiencing a biometric state only half corresponding to the particular and/or additional biometric characteristic as only half a viewer. Determining how closely a biometric state corresponds to the particular and/or additional biometric characteristic may involve calculating the multidimensional Euclidian distance between the biometric state and the particular and/or additional biometric characteristic, where each biometric measurement that makes up the biometric characteristic is a separate dimension, and where each dimension is normalized by an average value for the biometric measurement for the user and/or the overall population, by a maximum value for the biometric measurement for the user and/or the overall population, and/or a weight corresponding to the importance of the biometric measurement in determining whether the user is experiencing a biometric state corresponding to the biometric measurement.

It will be apparent to those of ordinary skill in the art that the systems and methods involved in the present application may be embodied in a computer program product that includes a computer usable and/or readable medium. For example, the media guidance application and/or any instructions for performing any of the embodiments discussed herein may be encoded on machine readable media. Machine readable media includes any media capable of storing data. The machine readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, flash memory, Random Access Memory (“RAM”), etc.

It is understood that the various features, elements, or processes of the foregoing figures and description are interchangeable or combinable to realize or practice the implementations described herein. Those skilled in the art will appreciate that aspects of the application can be practiced by other than the described implementations, which are presented for purposes of illustration rather than of limitation, and the aspects are limited only by the claims which follow.

1. A method for selectively transmitting user interaction information, the method comprising:
associating a first biometric state of a user with information on a first plurality of interactions the user performed while the user experienced the first biometric state;
associating a second biometric state of the user with information on a second plurality of interactions the user performed while the user experienced the second biometric state;
receiving a request for user interaction information associated with a particular biometric characteristic from a server;
determining which of the first and second biometric states corresponds to the particular biometric characteristic; and
responsive to determining that the second biometric state corresponds to the particular biometric characteristic, transmitting the information on the second plurality of interactions to the server.

2. The method of claim 1, further comprising:
receiving biometric information from a biometric measurement device at a plurality of different times; and
wherein associating the second biometric state of the user with the information on the second plurality of interactions comprises determining, based on the most recently received biometric information, whether the user is experiencing the first biometric state or the second biometric state.

3. The method of claim 1, further comprising:
receiving at least one user command corresponding to at least one of the second plurality of interactions;
responsive to the at least one user command, receiving biometric information from a biometric measurement device; and
wherein associating the second biometric state of the user with the information on the second plurality of interactions comprises determining, based on the biometric information received responsive to the at least one user command, whether the user is experiencing the first biometric state or the second biometric state.

4. The method of claim 3, further comprising:
responsive to receiving the at least one user command, transmitting a request for the biometric information to the biometric measurement device; and
receiving the biometric information in response to the request.

5. The method of claim 1, further comprising:
associating a third biometric state of a second user with information on a third plurality of interactions the second user performed while the second user experienced the third biometric state;
determining which of the first, second, and third biometric states correspond to the particular biometric characteristic; and
responsive to determining that the second and third biometric states correspond to the particular biometric characteristic, transmitting the information on the second and third pluralities of interactions to the server.

6. The method of claim 1, wherein the particular biometric characteristic comprises one or more of a particular mood, a particular emotional state, and a range of at least one of heart rates, blood pressures, body temperatures, and breathing rates.

7. The method of claim 1, further comprising storing a historic biometric state for the user, wherein the historic biometric state indicates a value of a biometric measurement, and wherein the particular biometric characteristic comprises a range of values of the at least one biometric measurement relative to the historic biometric state.

8. The method of claim 1, wherein:
the particular biometric characteristic is associated with a heightened level of user attention;
the information on the second plurality of interactions comprises a user score for a media asset; and
the server uses user interaction information received from a plurality of user equipment devices to generate a reliable score for the media asset, wherein the received user interaction information comprises information on interactions of at least one user of each of the plurality of user equipment devices, and wherein the at least one user performed the interactions while experiencing a biometric state corresponding to the particular biometric characteristic.

9. The method of claim 1, wherein:
the particular biometric characteristic is associated with laughter;
the information on the second plurality of interactions comprises information identifying a plurality of media assets; and
the server uses user interaction information received from a plurality of user equipment devices to identify comedy media assets, wherein the received user interaction information comprises information on interactions of at least one user of each of the plurality of user equipment devices, and wherein the at least one user performed the interactions while experiencing a biometric state corresponding to the particular biometric characteristic.

10. The method of claim 1, wherein:
the particular biometric characteristic is associated with fear;
the information on the second plurality of interaction information comprises information identifying a plurality of media assets; and
the server uses user interaction information received from a plurality of user equipment devices to identify horror media assets, wherein the received user interaction information comprises information on interactions of at least one user of each of the plurality of user equipment devices, and wherein the at least one user performed the interactions while experiencing a biometric state corresponding to the particular biometric characteristic.

11. A system for selectively transmitting user interaction information, the system comprising:
control circuitry configured to:
associate a first biometric state of a user with information on a first plurality of interactions the user performed while the user experienced the first biometric state;
associate a second biometric state of the user with information on a second plurality of interactions the user performed while the user experienced the second biometric state;
receive a request for user interaction information associated with a particular biometric characteristic from a server;
determine which of the first and second biometric states corresponds to the particular biometric characteristic; and
responsive to determining that the second biometric state corresponds to the particular biometric characteristic, transmit the information on the second plurality of interactions to the server.

12. The system of claim 11, wherein the control circuitry is further configured to:
receive biometric information from a biometric measurement device at a plurality of different times; and
wherein the control circuitry is configured to associate the second biometric state of the user with the information on the second plurality of interactions by being further configured to determine, based on the most recently received biometric information, whether the user is experiencing the first biometric state or the second biometric state.

13. The system of claim 11, wherein the control circuitry is further configured to:
receive at least one user command corresponding to at least one of the second plurality of interactions;
responsive to the at least one user command, receive biometric information from a biometric measurement device; and
wherein the control circuitry is configured to associate the second biometric state of the user with the information on the second plurality of interactions by being further configured to determine, based on the biometric information received responsive to the at least one user command, whether the user is experiencing the first biometric state or the second biometric state.

14. The system of claim 13, wherein the control circuitry is further configured to:
responsive to receiving the at least one user command, transmit a request for the biometric information to the biometric measurement device; and
receive the biometric information in response to the request.

15. The system of claim 11, wherein the control circuitry is further configured to:
associate a third biometric state of a second user with information on a third plurality of interactions the second user performed while the second user experienced the third biometric state;
determine which of the first, second, and third biometric states correspond to the particular biometric characteristic; and
responsive to determining that the second and third biometric states correspond to the particular biometric characteristic, transmit the information on the second and third pluralities of interactions to the server.

16. The system of claim 11, wherein the particular biometric characteristic comprises one or more of a particular mood, a particular emotional state, and a range of at least one of heart rates, blood pressures, body temperatures, and breathing rates.

17. The system of claim 11, wherein the control circuitry is further configured to store a historic biometric state for the user, wherein the historic biometric state indicates a value of a biometric measurement, and wherein the particular biometric characteristic comprises a range of values of the at least one biometric measurement relative to the historic biometric state.

18. The system of claim 11, wherein:
the particular biometric characteristic is associated with a heightened level of user attention;
the information on the second plurality of interactions comprises a user score for a media asset; and
the server uses user interaction information received from a plurality of user equipment devices to generate a reliable score for the media asset, wherein the received user interaction information comprises information on interactions of at least one user of each of the plurality of user equipment devices, and wherein the at least one user performed the interactions while experiencing a biometric state corresponding to the particular biometric characteristic.

19. The system of claim 11, wherein:
the particular biometric characteristic is associated with laughter;
the information on the second plurality of interactions comprises information identifying a plurality of media assets; and
the server uses user interaction information received from a plurality of user equipment devices to identify funny media assets, wherein the received user interaction information comprises information on interactions of at least one user of each of the plurality of user equipment devices, and wherein the at least one user performed the interactions while experiencing a biometric state corresponding to the particular biometric characteristic.

20. The system of claim 11, wherein:
the particular biometric characteristic is associated with fear;
the information on the second plurality of interaction information comprises information identifying a plurality of media assets; and
the server uses user interaction information received from a plurality of user equipment devices to identify scary media assets, wherein the received user interaction information comprises information on interactions of at least one user of each of the plurality of user equipment devices, and wherein the at least one user performed the interactions while experiencing a biometric state corresponding to the particular biometric characteristic.

21-50. (canceled)
